(19) United States
(12) Patent Application Publication
(10) Pub. No.: US 2007/0279531 A1
(43) Pub. Date: Dec. 6, 2007

(54) TV receiver and TV receiving method

(75) Inventor: Yasuhiko Muto, Fukaya-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/802,992

(22) Filed: May 29, 2007

(30) Foreign Application Priority Data
May 30, 2006 (JP) 2006-150567

(51) Int. Cl. H04N 7/01; H04N 5/202

(52) U.S. Cl. 348/674; 348/441

(57) ABSTRACT

According to one embodiment, a TV receiver comprising: an input unit to which a video signal is input; a motion picture detecting unit that detects a motion picture on the video signal; a frame rate doubling unit that performs a frame rate doubling conversion on the video signal of each frame; an RGB gamma correcting unit that varies an RGB gamma correction characteristic at each of fields, on the basis of a detected result by the motion picture detecting unit; and a display unit that displays an output signal of the RGB gamma correcting unit.

### CROSS-REFERENCE TO RELATED APPLICATIONS

This application is based upon and claims the benefit of priority from JP-A-2006-150567, filed May 30, 2006, the entire contents of which are incorporated herein by reference.

### BACKGROUND

1. Field

One embodiment of the invention relates to a TV receiver and a TV receiving method which performs RGB gamma corrections.

2. Description of the Related Art

In recent years, as is well known, flat panel type large-screen displays have been developed and put into practical use in the form of TV broadcast receivers. Incidentally, as for the display method, whereas CRT displays perform impulse-type display in which each pixel emits light only instantly in each screen display period, large-screen displays of this type perform hold-type display in which each pixel maintains the same light output level during each screen display period. As a result, large-screen displays of this type show a blurred image when inputting a motion picture, because of this operation scheme and a human visual characteristic.

Patent document, JP-A-2005-3897 discloses, as a countermeasure against the above blurred image, a method in which two display frames are generated from each input frame of a video signal and used for display on a liquid crystal display screen. That is, two display frames which are different from each other in luminance are generated and alternately used for display on a liquid crystal display screen in each frame period. However, this method is directed to a static characteristic and does not enable dynamic processing which the invention aims at principally.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of a first embodiment of the present invention, that is, a video signal processing system of a TV broadcast receiver;

FIG. 2 is an exemplary block diagram showing the details of an important part of the first embodiment;

FIG. 3 is an exemplary schematic graph showing a frame rate doubling operation of the first embodiment;

FIG. 4 is an exemplary schematic graph showing an RGB gamma correcting operation of the first embodiment;

FIG. 5 is an exemplary block diagram showing the details of an important part of a second embodiment;

FIG. 6 is an exemplary graph showing histogram data used in the second embodiment;

FIG. 7 is an exemplary block diagram showing the details of an important part of a third embodiment; and

FIG. 8 is an exemplary table showing a judgment method of an operation circuit of the third embodiment.

### DETAILED DESCRIPTION

Various embodiments according to the invention will be described hereinafter with reference to the accompanying drawings. In general, according to one embodiment of the invention, a TV receiver comprising: an input unit to which a video signal is input; a motion picture detecting unit that detects a motion picture on the video signal; a frame rate doubling unit that performs a frame rate doubling conversion on the video signal of each frame; an RGB gamma correcting unit that varies an RGB gamma correction characteristic at each of fields, on the basis of a detected result by the motion picture detecting unit; and a display unit that displays an output signal of the RGB gamma correcting unit.

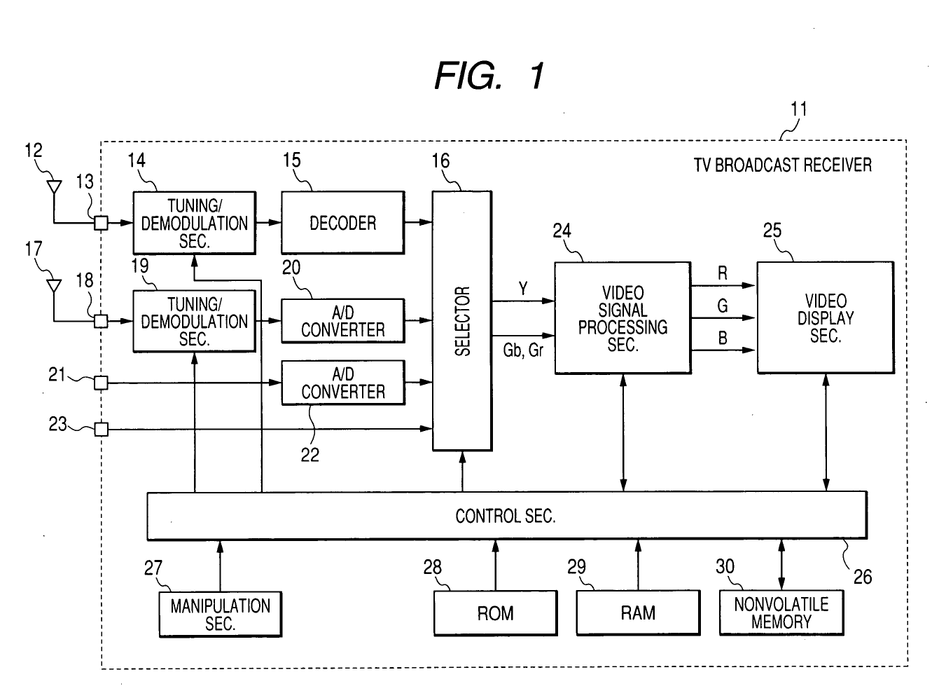

A first embodiment of the invention will be described below with reference to FIGS. 1-4.

FIG. 1 schematically shows a video signal processing system of a TV broadcast receiver 11 according to this embodiment. As shown in FIG. 1, digital TV broadcast signals received by an antenna 12 for digital TV broadcast reception are supplied to a tuning/demodulation section 14 via an input terminal 13. The tuning/demodulation section 14 selects a broadcast signal of a desired channel from the input digital TV broadcast signals, demodulates the selected signal, and outputs a demodulated signal to a decoder 15.

The decoder 15 performs decoding processing on the signal received from the tuning/demodulation section 14 and thereby generates a digital luminance signal Y and chroma signal Cb/Cr, which are output to a selector 16.

Analog TV broadcast signals received by an antenna 17 for analog TV broadcast reception are supplied to a tuning/demodulation section 19 via an input terminal 18. The tuning/demodulation section 19 selects a broadcast signal of a desired channel from the input analog TV broadcast signals and demodulates the selected signal into an analog luminance signal Y and chroma signal Cb/Cr.

The analog luminance signal Y and chroma signal Cb/Cr generated by the tuning/demodulation section 19 are supplied to an A/D (analog/digital) converter 20, where they are converted into a digital luminance signal Y and chroma signal Cb/Cr, which are output to the selector 16.

An analog luminance signal Y and chroma signal Cb/Cr which are supplied to an external input terminal 21 for an analog video signal are supplied to an A/D converter 22, where they are converted into a digital luminance signal Y and chroma signal Cb/Cr, which are output to the selector 16. Furthermore, a digital luminance signal Y and chroma signal Cb/Cr which are supplied to an external input terminal 23 for a digital video signal are supplied to the selector 16 as they are.

The selector 16 selects one of the sets of a digital luminance signal Y and chroma signal Cb/Cr which are supplied from the decoder 15, the A/D converters 20 and 22, and the external input terminal 23, and supplies the selected digital luminance signal Y and chroma signal Cb/Cr to a video signal processing section 24. As described above, the selector 16 and its upstream sections and so on constitute an input means.

As described later in detail, the video signal processing section 24 generates R (red), G (green), and B (blue) signals by performing prescribed signal processing on the received digital luminance signal Y and chroma signal Cb/Cr.

The R, G, and B signals generated by the video signal processing section 24 are supplied to a video display section 25 and used for video display. For example, the video display section 25 is a flat panel display such as a liquid crystal display or a plasma display.

In the TV broadcast receiver 11, a control section 26 controls, in a unified manner, various operations including the above-described various receiving operations. Being a microprocessor incorporating a CPU (central processing unit) and so on, the control section 26 receives manipulation information from a manipulation section 27 including a remote controller (not show) and controls the individual sections so that they operate so as to reflect a manipulation content of the manipulation information.

In doing so, the control section 26 mainly uses a ROM (read-only memory) 28 in which control programs to be run by the CPU are stored, a RAM (random access memory) 29 for providing a work area for the CPU, and a nonvolatile memory 30 in which various kinds of setting information, control information, and so on are stored.

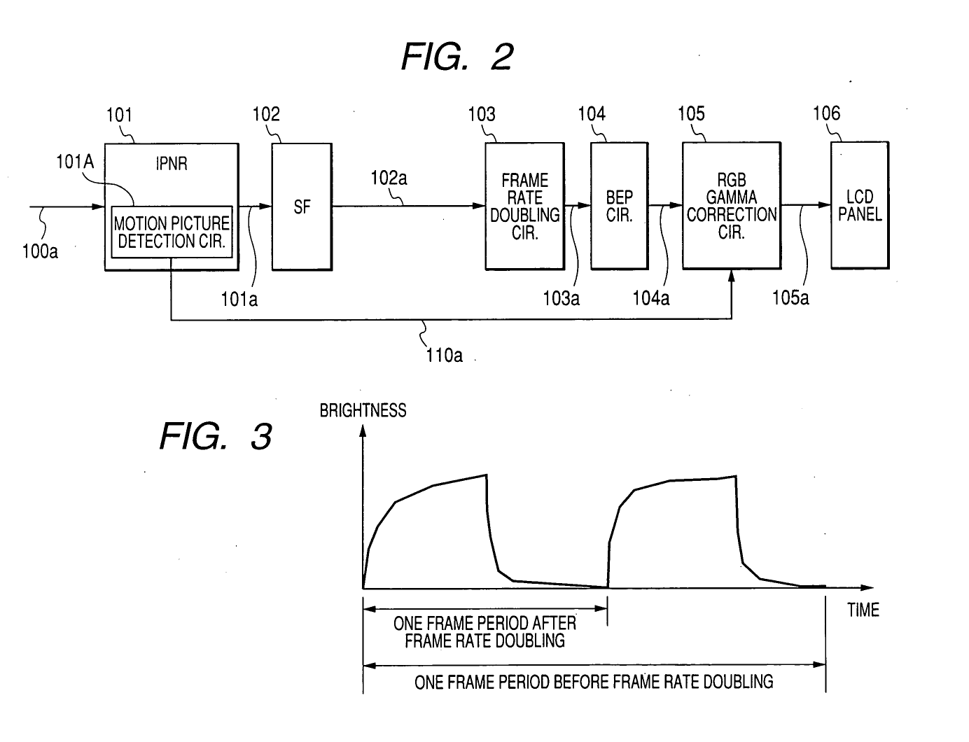

FIG. 2 shows examples of the video processing section 24 and the video display section 25. In FIG. 2, an LCD panel 106 corresponds to the video display section 25 shown in FIG. 1 and the other circuits are components of the video processing section 24 shown in FIG. 1. Input/output signal lines connected to the control section 26 are omitted and the other input/output signal lines are simplified.

A digital luminance signal Y and chroma signal Cb/Cr that are selected by the selector 16 are supplied, as video signals 100a, to an interlace-progressive conversion/noise reduction (IPNR) circuit 101 which is an image quality enhancement circuit. Resulting signals 101a are supplied to a scaling (SF) circuit 102 to adjust the signals 101a to the display size of the display device 106; the signals 101a are converted into signals 102a.

A frame rate doubling circuit 103 doubles the frame frequency. That is, if the frame frequency of the video signals 100a is 50 Hz, it is doubled to 100 Hz. If the frame frequency of the video signals 100a is 60 Hz, it is doubled to 120 Hz. Resulting frequency-doubled signals 103a are subjected to image quality processing by an image quality circuit (BEP circuit) 104, and resulting image-quality-processed signals 104a are supplied to an RGB gamma correction circuit 105.

On the other hand, a moving image detection circuit 101A in the IPNR circuit 101 is a circuit for detecting motion of the video signals 100a and can produce motion information 110a. This information is also used for interlace-progressive conversion and noise reduction. For example, the moving image detection circuit 101A compares pixels of a current frame or field with pixels, located at the same positions, of the preceding frame or field, counts the number of pixels in which a difference is found, and classifies a total number into several groups. For example, a total number may be classified into group “0” (judged to be a still picture) and-groups “1” to “8” (judged to be a motion picture) in ascending order of the total number.

The RGB gamma correction circuit 105 adds, for each display frame, a nonlinear characteristic of intermediate luminance enhancement/reduction in such a manner that it is varied in accordance with the motion amount of the motion information 110a. Resulting correction signals 105a are supplied to the display device 106 and used for display.

FIG. 3 is a schematic graph showing an operation of the frame rate doubling circuit 103. The horizontal axis represents the time and the vertical axis represents the luminance. Two frames are output in one original frame period, which means that the frame frequency has been doubled. For each field, the luminance is enhanced first and then black is inserted.

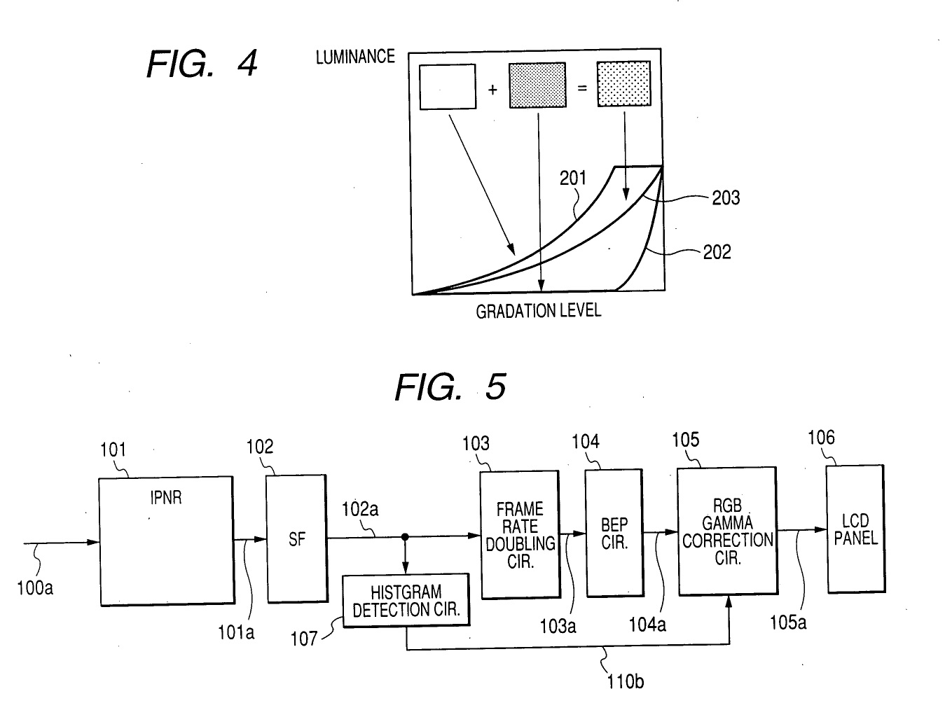

FIG. 4 is a schematic graph showing an operation of the RGB gamma correction circuit 105. The horizontal axis represents the gradation level and the vertical axis represents the luminance. A curve 201 in FIG. 4 corresponds to timing when the luminance is enhanced in FIG. 3, and a curve 202 in FIG. 4 corresponds to timing when black is inserted in FIG. 3. The gamma characteristic of an original image is maintained as a whole as indicated by a curve 203 in FIG. 3. It is desirable to control the amount of intermediate luminance enhancement/reduction in accordance with the magnitude of the output of the moving image detection circuit 101A.

The nonlinear characteristic of the RGB gamma correction circuit 105 can lower the degree of blurring of a motion picture.

A second embodiment of the invention will be described below with reference to FIGS. 1 and 3-6. Descriptions of sections and so on having the same ones in the first embodiment will be omitted.

FIG. 5 is a block diagram showing the details of an important part of the embodiment. The nonlinear characteristic of intermediate luminance enhancement/reduction of the RGB gamma correction circuit 105 is varied in accordance with histogram information 110b (luminance) obtained by a histogram detection circuit 107, whereby the degree of blurring of a motion picture image can be lowered.

Histogram data are obtained by dividing a luminance dynamic range into n levels and counting the numbers of pixels corresponding to respective luminance levels 1 to n for each frame of a video signal. It is assumed that the resolution of the luminance levels 1 to n is set sufficiently high. For example, when an input video signal is of 8 bits, the resolution of luminance levels used for acquiring histogram data is also set at 8 bits.

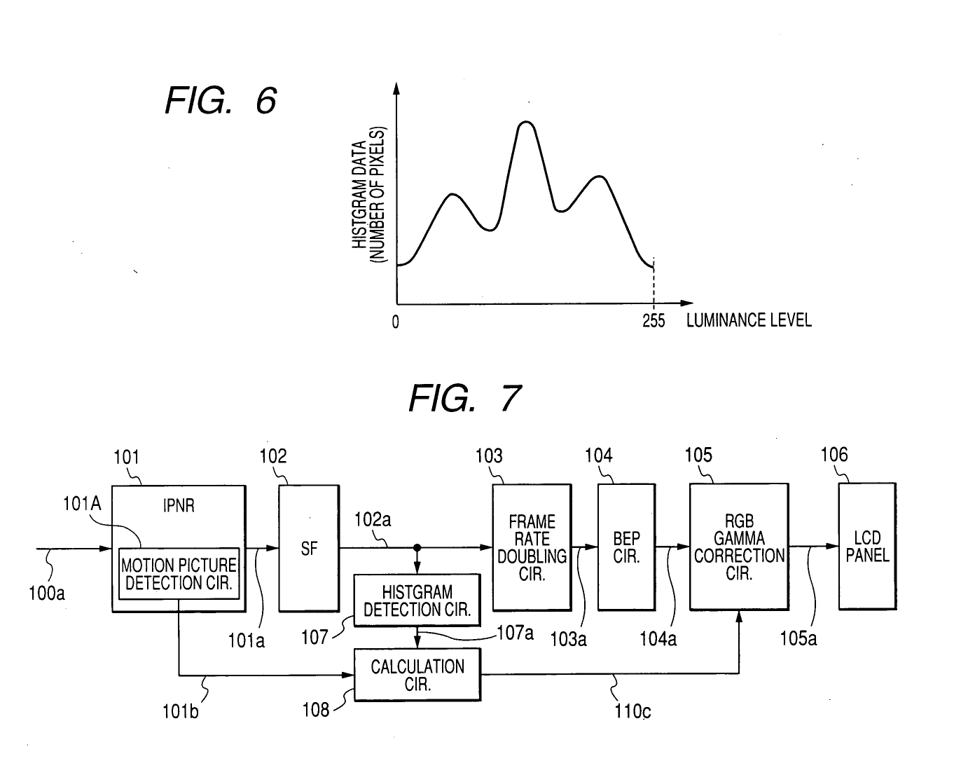

FIG. 6 shows exemplary luminance histogram data of one frame that are acquired in the above-described manner. In this case, the resolution of luminance levels is 8 bits (0-255). That is, the number of pixels is acquired for each of the 256 luminance levels (0-255). Therefore, the sum of the numbers of pixels corresponding to all the luminance levels is equal to the number of pixels of one frame of an input video signal.

Each luminance level of 8 bits may further be divided into sub-levels, for example, into sub-levels 1-8 (in ascending order of luminance).

Furthermore, in the second embodiment, the nonlinear characteristic of intermediate luminance enhancement/reduction of the RGB gamma correction circuit 105 is varied in accordance with not only the histogram information 110b (luminance) but also the variation of the luminance difference between frames, whereby the degree of blurring of a moving image can be lowered. For example, the following judgment algorithm is employed. In general, plural “certain values” are used.

As a result of histogram detection,

if the luminance is higher than a certain value2: the intermediate luminance enhancement/reduction amount is decreased; and
if the luminance is lower than the certain value2: the intermediate luminance enhancement/reduction amount is increased; or
if the luminance is higher than a certain value1: the intermediate luminance enhancement/reduction amount is set at 0; and
if the luminance is lower than the certain value1: the intermediate luminance enhancement/reduction amount is set at a certain fixed value.
As an AND result of the above operations,

if the luminance is higher than certain value1: the intermediate luminance enhancement/reduction amount is set at 0;
if the luminance is between certain value-1 and certain value2: the intermediate luminance enhancement/reduction amount is decreased; and
if the luminance is lower than certain value2: the intermediate luminance enhancement/reduction amount is increased.

A third embodiment of the invention will be described below with reference to FIGS. 1, 3-4, and 7-8. Descriptions of sections and so on having the same ones in the first or second embodiment will be omitted.

FIG. 7 is a block diagram showing the details of an important part of the embodiment. The nonlinear characteristic of intermediate luminance enhancement/reduction of the RGB gamma correction circuit 105 is varied in accordance with information 110c that is generated on the basis of an output signal 101b of the moving image detection circuit 101a and an output signal 107a of the histogram detection circuit 107, whereby the degree of blurring of a motion picture can be lowered.

Assume that, as described in the first and second embodiments, motion amount groups 1-8 and histogram luminance levels 1-8 are employed.

As for the algorithm of the operation circuit 108, it is desirable to use a proper one of the following judgment schemes for a subject signal:

1. A maximum value of motion amounts or histogram luminance levels.

2. A minimum value of motion amounts or histogram luminance levels.

3. An average value of motion amounts or histogram luminance levels.

4. Judgment using an 8×8 matrix.

Alternatively, the above judgment schemes may be combined with each other.

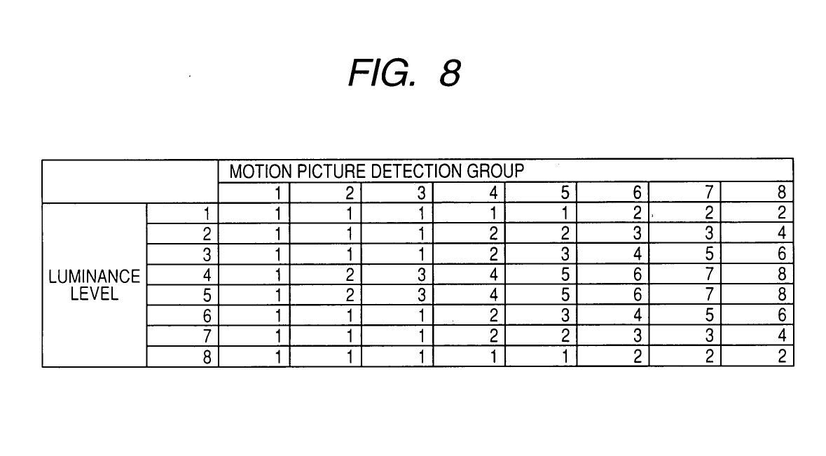

FIG. 8 shows an exemplary method in which a judgment is made using an 8×8 matrix (the above item 4). The output level range is also 1 to 8. The judgment scheme is such that the output increases with the degree of motion detection in a halftone range (in other words, the luminance gradation level is in an intermediate range). The RGB gamma correction circuit uses this judgment result.

As described with reference to the embodiment, there is provided a TV receiver and a TV receiving method which perform RGB gamma corrections dynamically. According to the RGB gamma correcting means, the embodiment can reduce the degree of blurring of an image that a viewer tends to feel when a moving image is displayed, without lowering the luminance or contrast.

The invention is not limited to the above embodiments themselves and can be practiced in such a manner that the components are modified in various forms without departing from the spirit and scope of the invention. Various apparatus covered by the invention can be constructed by properly combining plural components disclosed in the above embodiments. For example, several components may be removed form all the components of each embodiment. Furthermore, parts of the components of different embodiments may be combined together as appropriate.

As described with reference to the embodiment, there is provided a TV receiver and a TV receiving method which perform RGB gamma corrections dynamically.

What is claimed is:

1. A TV receiver, comprising:
an input unit to which a video signal is input; a motion picture detecting unit that detects a motion picture on the video signal;
a frame rate doubling unit that performs a frame rate doubling conversion on the video signal of each frame;
an RGB gamma correcting unit that varies an RGB gamma correction characteristic at each of fields, on the basis of a detected result by the motion picture detecting unit; and
a display unit that displays an output signal of the RGB gamma correcting unit.

2. A TV receiver, comprising:
an input unit to which a video signal is input;
an acquiring unit that acquires a histogram data of respective luminance levels from a luminance signal included in the video signal of each frame;
a frame rate doubling unit that performs a frame rate doubling conversion on the video signal of each frame;
an RGB gamma correcting unit that varies an RGB gamma correction characteristic at each field, on the basis of the histogram data; and
a display unit that displays an output signal of the RGB gamma correcting unit.

3. The TV receiver according to claim 1, further comprising:
an acquiring unit that acquires, on the video signal of each frame, a histogram data of respective luminance levels from a luminance signal received from the input unit; and
a calculation unit that generates a correction information on the basis of detected result by the motion picture detecting unit and the histogram data;
wherein the RGB gamma correcting unit that varies the RGB gamma correction characteristic at each field, on the basis of the correction information;

4. The TV receiver according to claim 3,
wherein the calculation unit uses at least one of a maximum luminance level, a minimum luminance level, and an average luminance level of the histogram data.

5. The TV receiver according to claim 3,
wherein the calculation unit uses a matrix table of the correction information.

6. A TV receiving method, comprising:
receiving an video signal;
detecting a motion picture on the received video signal;
performing a frame rate doubling conversion on each frame of the video signal;
varying an RGB gamma correction characteristic at each field of the video signal, on the basis of a detected result by the motion picture detecting;
performing an RGB gamma correction on each field of the video signal; and
displaying the video signal on which the RGB gamma correction performed.

7. The TV receiving method according to claim 6, further comprising:
acquiring, on the video signal of each frame, a histogram data of respective luminance levels from a luminance signal of the received video signal; and
generating a correction information on the basis of the detected result of the motion picture detection and the histogram data;
wherein, when varies the RGB gamma correction characteristic, the variation is based on the result of the motion picture detection and the histogram data.

8. The TV receiving method according to claim 7,
wherein generating step includes generating the correction information using at least one of a maximum luminance level, a minimum luminance level, and a average luminance level of the histogram data.

9. The TV receiving method according to claim 7,
wherein, the generating step includes generating the correction information generated by using a matrix table of the correction information.
